(19) United States
(12) Patent Application Publication
(10) Pub. No.: US 2015/0354292 A1
(43) Pub. Date: Dec. 10, 2015

(54) UMBILICAL

(71) Applicant: TECHNIP FRANCE, Courbevoie (FR)

(72) Inventors: Steven John FRAZER, Killingworth (GB); David MADDEN, League City, TX (US)

(21) Appl. No.: 14/758,456

(22) PCT Filed: Dec. 12, 2013
(86) PCT No.: PCT/IB2013/002936

§ 371 Date: Jun. 29, 2015

(30) Foreign Application Priority Data
Dec. 31, 2012 (GB) 1223500.8

(51) Int. Cl. E21B 17/20; B32B 5/12; E21B 17/00; G02B 6/44; H01B 7/18; F16L 11/12; B32B 1/08; B32B 5/26

(52) U.S. Cl. CPC E21B 17/206; B32B 1/08; B32B 5/12; B32B 5/26; G02B 6/4432; H01B 7/1875; F16L 11/12; E21B 17/20; E21B 17/003; B32B 2250/04; B32B 2262/02; B32B 2307/546; B32B 2597/00; B32B 2457/00; B32B 2551/00

(57) ABSTRACT

An offshore hydrocarbon-production umbilical having concentrically: an outer sheath, at least two cross-wound armouring layers, and a core enclosed by the armouring layers, and comprising a plurality of elongate active umbilical components, wherein each armouring layer comprises a plurality of reinforced polymer strips. The use of reinforced polymer strips to form the armouring layers achieves a reduced weight but still flexible arrangement, which is significantly easier to manufacture as far fewer strips are required to form the armouring layers compared with the large number of steel wires of conventional armouring layers.

The present invention relates to an offshore hydrocarbon-production umbilical, and in particular to an IWOCS umbilical, and to a method of manufacture.

Umbilicals used in the offshore production of hydrocarbons generally comprise a group of one or more types of elongated active umbilical components, such as electrical cables, optical fibre cables, steel pipes and/or hoses, cabled together for flexibility, over-sheathed and, when applicable, armoured for mechanical strength. Umbilicals are typically used for transmitting power, signals and/or working fluids (for example for fluid injection, hydraulic power, gas release, etc.) to and from a subsea installation.

The umbilical cross-section is generally circular, the elongated elements being wound together either in a helical or in a S/Z pattern. In order to fill the interstitial voids between the various umbilical elements and to obtain the desired configuration, filler components may be included within the voids.

API 17E and ISO 13628-5 “Specification for Subsea Umbilicals”, provide standards for the design and manufacture of such umbilicals.

Subsea umbilicals are now being installed at increasingly deeper water depths, commonly being deeper than 2000m. Such umbilicals therefore have to be able to withstand the increasingly severe loading conditions during their installation and their service life.

A particular use of such umbilicals is in an ‘Installation and WorkOver Control System’ (hereinafter “IWOCS”). The IWOCS is used to monitor and control the deployment and operation of subsea production equipment such as subsea trees. The same system is also used for the retrieval and work of such equipment. IWOCS generally offers monitoring and control of the deployment and retrieval of tubing hangers, landing strings and subsea trees, as well as facilities for downhole operations, well testing and production testing.

An IWOCS umbilical is general able to connect the subsea equipment to a ‘top side’ control unit, which typically has a reel and/or winch to deploy the umbilical, a workover control container, and local control panels on the rig.

IWOCS umbilicals can be designed to include as many hydraulic connections as requested by the designer or operator for operation of the necessary hydraulic and electrical control functions, and to provide monitoring and testing during installation, intervention and workover of subsea completion equipment.

In particular, IWOCS umbilicals are usually desired to be easy to install and recover with a simple winch/reel arrangement. During their operation and use, they are often reeled on and off drums many times, and subject to highly dynamic environments. As a consequence, IWOCS umbilicals need to be a light weight, flexible (i.e. with a low bending stiffness), and highly resistant to tensile and bending loadings.

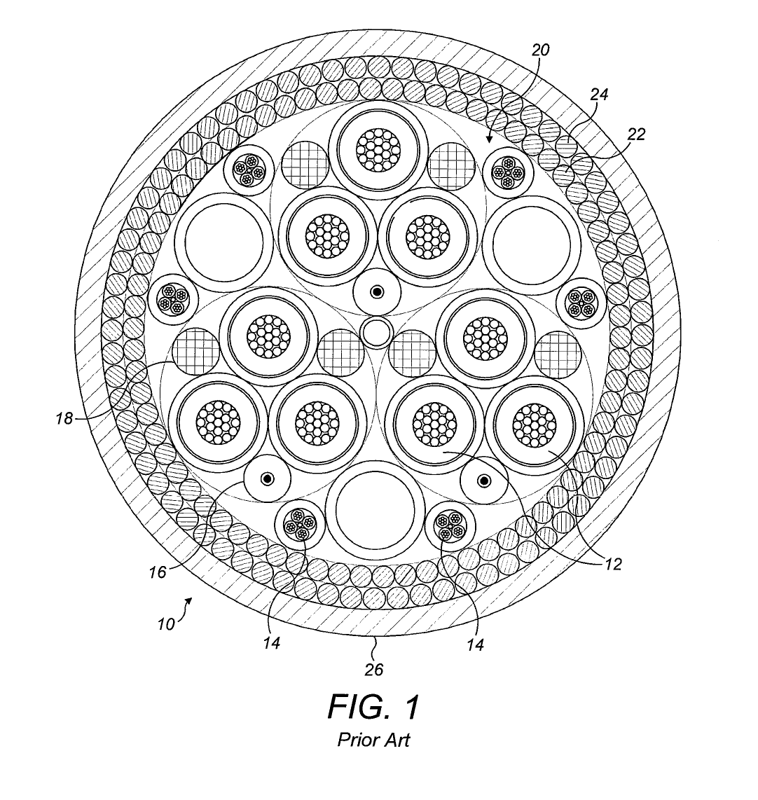

The main load carrying components in charge of withstanding the tensile loads due to the suspended weight of the umbilical below a laying ship are usually tubes (see for example as described in U.S. Pat. No. 6,472,614, WO93/17176, GB2316990), steel rods (U.S. Pat. No. 6,472,614), composite rods (WO2005/124095, US2007/0251694), steel ropes (GB2326177, WO2005/124095), composites ropes (GB2326177), or tensile armour layers (see for example FIG. 1 of U.S. Pat. No. 6,472,614). The other components in the umbilical, i.e. the electrical and optical cables, the thermoplastic hoses, the polymeric external sheath and the polymeric filler components, do not contribute significantly to the tensile strength of the umbilical.

Under severe conditions, such as use in deep water and/or in dynamic applications, increased loads will be applied to the umbilical due to the weight of the umbilical and to the dynamic movement of water. Thus, strengthening elements and ballast elements have been added to umbilicals to withstand these loads. In particular, API specification 17E suggests adding external layers of armouring wires wound helically around the umbilical.

FIG. 1 of the accompanying drawings is a cross-sectional view of a conventional umbilical 10 for use in the offshore production of hydrocarbons. It includes three large power conductors, each having three electrical power cables 12, electrical signal cables 14, optical fibre cables 16, reinforcing steel or carbon rods 18, etc., optionally with a filler thereinbetween, and which together form a core 20. Around the core 20 are two cross-wound tensile armour layers 22, 24 comprising a large number of galvanized cylindrical steel wires in a manner known in the art; see for example the armouring wires 12 in U.S. Pat. No. 6,472,624. The armour layers 22, 24 are then surrounded by an outer sheath 26.

Whilst the steel wire armour layers 22 and 24 can provide additional strength and ballast, they naturally increase the overall weight of the umbilical. As the water depth increases and/or the dynamic activity increases, the suspended weight also increases, until a limit is reached at which the umbilical is not able to support its own suspended weight.

It is known to provide armour layers based on using non-steel or non-metal wires or ropes, such as woven or non-woven aramid fibres braided at low angles. Such fibres can provide ‘rope like’ strength whilst being a lot lighter than steel. However, this arrangement has at least three known problems.

Firstly, this arrangement is expensive to manufacture in large diameter as large diameter braiding machines are not a ‘standard’ design, and so need to be especially developed. Even the addition of the large number of steel wires as shown in FIG. 1 herewith is expensive because of the need to use large size armouring machines in order to manage the large number of steel wires at the same time.

Secondly, as the umbilicals are reeled on and off drums, and subject to other dynamic environments, flexing of the umbilicals causes the braids to move, and continuous flexing eventually causes the braids to degrade at the “contact points” or “knuckles”.

In addition, as such umbilicals are spooled on and off a drum, the load within the tensile member causes a downward force into the belly of the drum, and in some cases causes the fibre-based strength members, such as aramid braided ropes, to move through the bundle, damaging the adjacent component. This is known as the ‘cheese wiring’ effect.

It is an object of the present invention to provide an umbilical with improved strength, able to withstand repeated flexing, whilst also having an easy method of manufacture.

Thus, according to one aspect of the present invention, there is provided an offshore hydrocarbon-production umbilical comprising concentrically: an outer sheath,
at least two cross-wound armouring layers, and
a core enclosed by the armouring layers, and comprising a plurality of elongate active umbilical components,
characterized in that each armouring layer comprises a plurality of reinforced polymer strips.

The use of reinforced polymer strips to form the armouring layers achieves a reduced weight but still flexible arrangement, which is significantly easier to manufacture as far fewer strips are required to form the armouring layers compared with the large number of steel wires shown in FIG. 1. In particular, the winding of the armouring layers can be carried out with small ‘standard’ winding machines, leading to a cost reduction compared with prior art armouring manufacturing steps.

Optionally, the use of a plurality of reinforced polymer strips provides an umbilical which has a low bending stiffness, such as below 1200 Nm. This can be contrasted with the use of round armor wires such as shown in FIG. 1 of the accompanying drawings, where each layer would provide a bending stiffness of 800 Nm or more, making an overall bending stiffness of at least 1600 Nm; or the use of braiding, which in itself has a low bending stiffness, but which itself must be sandwiched between sheaths having a bending stiffness that can be over 1200 Nm for a typical IWOCS of 90 mm to 140 mm OD.

Measurements of the bending stiffness (that can be formed around the required radius of the guiding sheaths by hand and self weight (typical radius of 1-2 m)) of two counter helical layers of reinforced polymer strips of the present invention have been in the range from 93 Nm to 259 Nm, and the use of two armouring layers formed by reinforced polymer strips of the present invention has been found to increase the stiffness of a single layer by only 20-30%, rather than simply doubling the bending stiffness.

The polymer strips may have their reinforcement provided by any suitable arrangement, generally involving the use of one or more strength-bearing pieces or units along the length of the polymer strips, and optionally embedded therein.

The reinforcement can be provided in a symmetrical or unsymmetrical manner, or a combination of same, and generally in one or more arrays, such arrays optionally being geometric, regular and/or parallel. The strands may be separate or touching. The possible separation of the strands within each reinforced polymer strip further removes the risk of their degradation from wear against each other during the umbilical service life and handling, in contrast to the steel wires in FIG. 1 herewith.

In a preferred embodiment, the at least two cross-wound armouring layers comprise the same number of the same or similar reinforced polymer strips. This embodiment is easy to manufacture, and is torque-balanced, or at least torque-balanced as far as possible.

The present invention could also be implemented using different reinforced polymer strips for each armouring layer, or in at least two different armouring layers, and/or a different number of reinforced polymer strips in each armouring layer, or in at least two different cross-wound armouring layers: provided that the resulting umbilical structure is torque-balanced, or at least torque-balanced as far as possible. For example, the reinforced polymer strips of two armouring layers could have different widths and/or different thicknesses and/or a different number of yarns and/or different kind of yarns (e.g. different materials, different number of fibres per yarn, etc.).

Optionally, the polymer strips are reinforced by one or more strands of one or more high strength organic yarns, optionally having a tensile modulus >70 GPa.

Optionally, the high strength organic yarns comprise fibres comprising one or more of the group comprising: aromatic polyamide (aramid) fibre, aromatic polyester fibre, liquid crystal fibre, high performance polyethylene fibre, and aromatic heterocyclic polymer fibre (PBO); preferably aromatic heterocyclic polymer fibre (PBO).

The or each strand may comprise any number of yarns. A plurality of yarns may form be twisted or braided or otherwise ‘wound’ together, being for example being at least 5 or at least 10 yarns, optionally in the range of 10-200, such as about 40 or 50 or 60 yarns. Forming strands of yarns is well known in the art, and can be contrasted with ‘solid’ strength members generally formed of a single solid material, or formed of fibres needed to be conjoined by a resin or other adhesive to form a “substantially solid” single entity to provide enough strength.

Preferably, the yarns are formed from aromatic heterocyclic polymer fibre (PBO).

In this regard, typical tensile strengths values for certain materials able to be used are:

| | Tensile | Tensile | |
|---|---|---|---|
| | Strength | Modulus | Specific Tensile |
| Material | (MPa) | (GPa) | Strength (Nm/kg) |
| Liquid crystal fibre - Vectran | 2900 | 103 | 2.07 × 10⁶ |
| Aramid fibre - Technora | 3440 | 79 | 2.47 × 10⁶ |
| (Available from Teijin) | | | |
| Aramid fibre - Kevlar 49 | 3600 | 102 to 110 | 2.5 × 10⁶ |
| (from DuPont) or Twaron | | | |
| D2200 (from Teijin) | | | |
| High Performance Polyethylene | 2620 | 107 | 2.70 × 10⁶ |
| fibre - Dyneema | | | |
| Aromatic Heterocyclic Polymer | 5500 | 180 | 3.52 × 10⁶ |
| fibre | | | |
| PBO - Zylon ® | | | |
| High Performance Polyethylene | 3510 | 270 | 3.62 × 10⁶ |
| fibre - Spectra | | | |

Such suitable high strength organic fibre formed yarns are light, and have high strength and high modulus strength, and include various high strength low stretch synthetic fibre strands made with either Zylon® fibre or aramid fibres, such as Kelvar or Twaron high modulus fibre, or liquid crystal fibre, such as Vectra fibre, or other high strength and high modulus synthetic fibres.

Kelvar fibres, such as K-29 and high modulus K-49 fibres are known.

The Twaron and Technora para-aramids also offer a combination of properties such as high strength, low weight, and high modulus (similar to Kelvar, such as Kevlar 49). Due to this combination of properties, the aramids fibres are used in protective garments. Twaron D2200 fibre is a particularly high modulus fibre (110-115 GPa) compared with normal standard aramid fibres. The aramid fibres have high strength and high modulus, good chemical and hydrolysis resistance, high temperature resistance, no corrosion, good dimensional stability, are non-magnetic and non-conductive, and light in weight.

Vectran is a high-performance thermoplastic multifilament yarn spun from Vectra® liquid crystal polymer (LCP). The fibre has high strength and modulus; excellent creep resistance and abrasion resistance; low moisture absorption and coefficient of thermal expansion (CTE) and high impact resistance.

The Zylon® fibre is a trade name of Poly (p-phenylene-2,6-benzobisoxazole) (PBO) fibre which is a rigid-rod isotropic crystal polymer. It has a strength and modulus almost double that of some para-aramid fibres. The PBO molecule is generally synthesized by condensing 4,6-diamino-1,3-benzenediol dihydrochloride with terephthalic acid (TA) or a derivative of TA such as terephthaloyl chloride in a poly-phosphoric acid (PPA) solution. “Zylon” is a registered trademark of Toyobo Co. Ltd. in Japan.

The Handbook of composites by Georges Lubin et al (1998) defines ‘aramid fibre’ as the generic term for a specific type of ‘aromatic polyamide fibre’. It states that the US Federal Trade Commission defines an aramid fibre as “a manufactured fibre in which the fibre-forming substance is a long-chain synthetic polyamide in which at least 85% of the amide linkages are attached directly to two aromatic rings”. Thus, in an aramid, most of the amide groups are directly connected to two aromatic rings, with nothing else intervening.

Generally, the reinforced polymer strips have a regular elongate cross section, and a length that is suitable in the forming process of the umbilical. The reinforced polymer strips may be provided in a pre-formed or shaped manner, whilst preferably being sufficiently flexible to allow their shape to be adapted to fit annularly around the core during manufacture of the umbilical.

The reinforced polymer strips may have any suitable dimensions and cross-section. Generally, the reinforced polymer strips have a rectangular cross-section.

Preferably, the reinforced polymer strips of one armouring layer overlap with the reinforced polymer strips of another armouring layer.

The use of reinforced polymer strips, generally having an elongate cross section, and optionally being ‘flat’, also increases the surface contact between the polymer strips of each armouring layer compared with individual cylindrical steel wires as shown in FIG. 1 herewith. The increased surface contact between the reinforced polymer strips reduces the pressure contact therebetween, and thus reduces the associated wear that occurs due to the moving of the armouring layers in use, especially whilst being reeled on and off drums.

Optionally, the reinforced polymer strips comprise one or more strands of one or more yarns embedded in a polymer matrix. The polymer of the polymer matrix may be any suitable high strength polymer, generally able to be formed (such as extruded, particularly pressure extruded), around the strands during manufacture of the reinforced polymer strips. Such polymers include high, medium and low density polyethylene, polyamide (nylon) and polyurethane.

The manufacturing process may involve any suitable steps or processes, generally intending to embed the strands within a curable matrix. By way of example, the required number of strands can be located on a spooling creel such that their ends can then be fed individually through tensioning devices into a die which arranges the strands into the desired internal arrangement, such as equally spaced parallel lines. The strands can then be fed through an extruder with a curing polymer extruded thereover to bind the strands into a thin rectangular strip.

Optionally, each reinforced polymer strip comprises at least two strands, optionally at least 4-20 strands, optionally in the range 4-12 strands, such as 6, 7, 8, 9 or 10 strands.

The reinforced polymer strips are provided to achieve a circular or annular array around the core of the umbilical, optionally in a symmetrical or otherwise balanced arrangement. That is, preferably a regular number of complete reinforced polymer strips provide a complete annulus around the core as an armouring layer. Optionally, the reinforced polymer strips are formed with dimensions adapted for the known or expected diameter of the core.

In one embodiment of the present invention, each armouring layer comprises between 5-25 reinforced polymer strips, optionally between 8-20 or 9-16 reinforced polymer strips. The present invention is flexible with regard to the number of strips required, based upon the known or expected diameter of the core, thickness of the strips, etc.

By way of example only, the reinforced polymer strips may have a thickness in the range 1 mm to 5 mm, preferably in the range 1.5 mm to 3 mm, and a width in the range 10 mm to 50 mm, preferably in the range 15 mm to 30 mm.

The strength of the reinforced polymer strips will vary depending upon the number of strands and yarns, the number and type of fibres forming the yarns, as well as the width or thickness of the strip. By way of example only, the yarns can have a fibre density of the range of 660 to 24,000 tex, giving the reinforced polymer strips a tensile load capacity in the range 1300 N to 20,000 N.

As mentioned above, an umbilical may consist of a group of one or more types of elongated active umbilical components, including but not limited to electrical cables, optical fibre cables, steel tubes, hoses, steel rods, composite rods, steel ropes and composite ropes, cabled together for flexibility. At least some of these elongated components form a core. In the present invention, the core may comprise at least an outer layer of a number of umbilical components.

The outer sheath may be made from any suitable material, generally being formed from one or more polymers, able to be formed around the armouring layers to provide an external protective layer, and optionally also a smooth layer.

The offshore hydrogen-production umbilical may be a thermoplastic, hybrid, HFL, IWOCS or power cable, preferably an IWOCS umbilical.

Optionally, the umbilical is for use at a depth of greater than 2000 m, preferably greater than 3000 m.

According to a second embodiment of the present invention, there is provided an IWO CS umbilical comprising consecutively:
an outer sheath,
at least two cross-wound armouring layers, and
a core enclosed by the armouring layers, and comprising a plurality of elongate active umbilical components,
characterized in that each armouring layer comprises a plurality of reinforced polymer strips as defined herein before.

The advantages of this IWOCS umbilical are described hereinabove.

According to a third aspect of the present invention, there is provided a method of manufacturing an offshore umbilical as defined herein before comprising at least the steps of:
(i) providing a core of comprising a plurality of elongate active umbilical components;
(ii) winding at least two armouring layers as defined herein before around the core; and
(iii) providing an oversheath.

As mentioned above, the winding of two armouring layers can be carried out with small ‘standard’ winding machines, leading to a cost reduction compared with the manufacturing steps required in the prior art to add conventional armouring. Indeed, the number of components required to form each armouring layer is now much lower than in the prior art, because the reinforced polymer strips are much wider than the prior art wires. Furthermore, the reinforced polymer strips are significantly more flexible than prior art wires, especially steel wires. Thus, the strips can be easily reeled off drums and wound around a cylindrical bundle during umbilical manufacture without requiring large and powerful machines, (as required for equivalent steel components).

The two armouring layers could be wound with a helix angle with an absolute value of between 5° and 25°, preferably between 5° and 10°. The two armouring layers are preferably cross-wound, and more preferably laid with opposite angles. For example a first armouring layer is laid at +12° and a second armouring layer is laid at −12°. This makes the offshore umbilical more torque-balanced, i.e. less likely to rotate when a tensile axial load is applied to it.

According to a fourth aspect of the present invention, there is provided a reinforced polymer strip for use in an offshore hydrocarbon-production umbilical, especially an IWOCS umbilical, wherein the polymer strip is reinforced by one or more strands of one or more high strength organic yarns comprising fibres comprising one or more of the group comprising; aromatic polyamide (aramid) fibre, aromatic polyester fibre, liquid crystal fibre, high performance polyethylene fibre, and aromatic heterocyclic polymer fibre (PBO), preferably aromatic heterocyclic polymer fibre (PBO).

Such strips significantly reduce the weight required to provide the armouring effect, whilst still providing a flexible arrangement, and provide a significantly easier method of umbilical manufacture as far fewer strips are required to form the armouring layers compared with the large number of steel wires shown in FIG. 1.

Embodiments of the present invention will now be described by way of example only and with reference to the accompanying drawings in which:

FIG. 1 is a cross-sectional view of an umbilical according to the prior art;

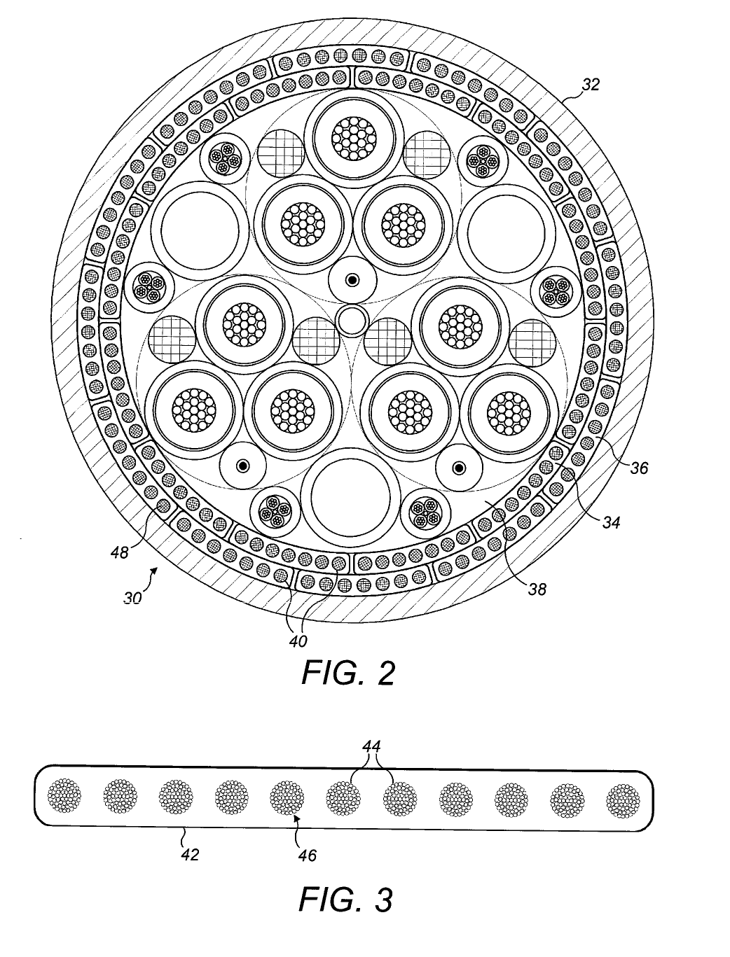

FIG. 2 is a cross-sectional view of an umbilical according to one embodiment of the present invention; and

FIG. 3 is a cross-sectional view of a portion of a reinforced polymer strip according to another embodiment of the present invention.

Referring to the drawings, FIG. 1 shows an umbilical 10 for use in the offshore production of hydrocarbons. It includes three large power conductors, each having three electrical power cables 12, electrical signal cables 14, optical fiber cables 16, reinforcing steel or carbon rods 18, etc., optionally with a filler thereinbetween, and which together form a core 20.

Around the core 20 are two cross-wound tensile armour layers 22, 24 comprising a large number of galvanized cylindrical steel wires in a manner known in the art. The armour layers 22, 24 are then surrounded by an outer sheath 26.

Whilst the steel wire armour layers 22 and 24 can provide additional strength and ballast, they naturally increase the overall weight of the umbilical. As the water depth increases and/or the dynamic activity increases, the suspended weight also increases, until a limit is reached at which the umbilical is not able to support its own suspended weight.

FIG. 2 shows an offshore hydrocarbon-production umbilical 30 comprising concentrically an outer sheath 32, first and second cross-wound armouring layers 34, 36, and a core 38 enclosed by the armouring layers 34, 36, and comprising a plurality of elongate active umbilical components. The umbilical 30 is characterized in that each armouring layer 34, 36 comprises a plurality of reinforced polymer strips 40.

The core 38 of the umbilical 32 comprises various umbilical components as described hereinbefore, and optionally a number being the same as those described in relation to the umbilical 10 shown in FIG. 1.

Similarly, the outer sheath 32 comprises a polymer, which can be same or different as the outer sheath 26 shown for the first umbilical 10 in FIG. 1.

FIG. 3 shows a reinforced polymer strip 42 for use in an offshore hydrocarbon-production umbilical such as the umbilical 30 shown in FIG. 2, wherein the polymer strip 42 is reinforced by one or more strands 46 of one or more high strength organic yarns 44. FIG. 3 shows the polymer strip 42 being reinforced by 11 strands 46, each strand 46 being formed of approximately 50 high strength organic yarns 44.

The yarns comprise fibres such as those described herein. A particular example of a suitable fibre is aramid fibres. The number and sizes of aramid fibres and yarns within a reinforced polymer strip will vary depending upon the required tensile strength of the strip. These could be in the range of 660 tex to 4000 tex fibre-based yarns. This would give a reinforced polymer strip a fibre tex range of 600 tex to 24,000 tex.

The reinforced polymer strip 42 can be formed by providing the required yarns onto a spooling creel, the ends of which are then fed individually through tensioning devices and into a ceramic closing die which arranges the yarns into an equally spaced, horizontal line. The yarns are then fed parallel through a cross head extruder and polymer is then pressure extruded over the yarns, binding them into a thin rectangular strip.

By placing the strands/yarns into a polymer strip there is no further contact with other strands, removing the risk of degradation from wear, both during the umbilical service life and handling during manufacture. This avoids the strands wearing due to their contact.

This arrangement also provides a number of strands in a single ‘piece’ (in the form of the strip), such that significantly fewer ‘pieces’ are required to form an annular armouring layer around the core of an umbilical, compared with the large number of steel wires as shown in FIG. 1. In particular, there is possibly at least a three-fold, five-fold or even ten-fold reduction in the number of ‘pieces’ required in FIG. 2 to form each armouring layer 34, 36, compared with the number of steel wires 22, 24 shown in FIG. 1. This provides a clear manufacturing advantage by removing the need for large braiding machines having many multiple individual feeding lines required to form the armouring layers 22, 24 in FIG. 1. Instead only a few feeding lines are required to provide the components to be wound around the core of an umbilical of the present invention. The reinforced polymer strips 40, 42, as they are also flexible, can still be reeled off drums and wound around a cylindrical bundle without requiring much larger or complex powerful machines for the armouring layers 22, 24 shown in FIG. 1.

Meanwhile, the provision of the two cross-wound armouring layers 34, 36 shown in FIG. 2 also still provides a torque-balanced arrangement of the armouring layers, which have no risk of unwinding, and a very stable construction.

FIG. 2 shows a first armouring layer 34 comprising 12 reinforced polymer strips 40, each reinforced polymer strip 40 comprising seven strands 48 in a parallel array or configuration. FIG. 2 shows the second armouring layer 36 comprising the same number of reinforced polymer strips 40, having the same number of reinforcing strands 48.

As mentioned above, the present invention is particularly suitable for forming an IWOCS umbilical, as the present invention can provide an umbilical with a low bending stiffness and be very resilient to tensile bending dynamic loadings (being the fatigue issue), whilst being easy to manufacture without requiring the use of expensive machines.

Optionally, the two armouring layers 34, 36 shown in FIG. 2 are counter-helically wound around the core 38 at a low angle, and optionally with one or more retaining tapes placed between the armouring layers 34, 36 to assist their cohesion in use.

Various modifications and variations to the described embodiments of the invention will be apparent to those skilled in the art without departing from the scope of the invention as defined herein. Although the invention has been described in connection with specific preferred embodiments it should be understood that the invention as defined herein should not be unduly limited to such specific embodiments.

1. An offshore hydrocarbon-production umbilical comprising concentrically:
an outer sheath,
at least two cross-wound armouring layers, and
a core enclosed by the armouring layers, and comprising a plurality of elongate active umbilical components,
wherein each armouring layer comprises a plurality of reinforced polymer strips, which form a complete annulus around the core as an armouring layer.

2. An umbilical as claimed in claim 1 wherein the umbilical has a bending stiffness below 1200 Nm.

3. An umbilical as claimed in claim 1 wherein the polymer strips are reinforced by one or more strands of one or more high strength organic yarns having a tensile modulus >70 GPa.

4. An umbilical as claimed in claim 3 wherein the high strength organic yarns comprise fibres comprising one or more of the group comprising; aromatic polyamide (aramid) fibre, aromatic polyester fibre, liquid crystal fibre, high performance polyethylene fibre, and aromatic heterocyclic polymer fibre (PBO), or a combination thereof.

5. An umbilical as claimed in claim 4 wherein the high strength organic fibres comprise aromatic heterocyclic polymer fibre (PBO).

6. An umbilical as claimed in claim 1 wherein each reinforced polymer strip comprises at least two strands, optionally at least 4-20 strands, and preferably in the range of 4-12 strands.

7. An umbilical as claimed in claim 6 wherein each reinforced polymer strip comprises 6, 7, 8, 9 or 10 strands.

8. An umbilical as claimed in claim 1 wherein each armouring layer comprises between 5-25 reinforced polymer strips, optionally between 8-20 or between 9-18 reinforced polymer strips.

9. An umbilical as claimed in claim 1 wherein the reinforced polymer strips have a thickness in the range 1 mm to 5 mm, and a width in the range 10 mm to 50 mm.

10. An umbilical as claimed in claim 1 wherein the reinforced polymer strips have a tensile load capacity in the range 1300 N to 20,000 N.

11. An umbilical as claimed in claim 1 wherein the reinforced polymer strips are wound in a helical pattern.

12. An umbilical as claimed in claim 1 wherein the umbilical is a thermoplastic, hybrid, HFL, IWOCS or power cable, preferably an IWOCS umbilical.

13. An umbilical as claimed in claim 1 for use at a depth of greater than 2000 m.

14. An IWOCS umbilical comprising consecutively:
an outer sheath,
at least two cross-wound armouring layers, and
a core enclosed by the armouring layers, and comprising a plurality of elongate active umbilical components,
wherein each armouring layer comprises a plurality of reinforced polymer strips as defined in claim 1 in the form of a complete annulus around the core.

15. A method of manufacturing an offshore umbilical as defined in claim 1 comprising at least the steps of:
(i) providing a core of comprising a plurality of elongate active umbilical components;
(ii) winding at least two armouring layers as defined in claim 1 around the core to form a complete annulus around the core; and
(iii) providing an oversheath.
